(19) United States
(12) Patent Application Publication
(10) Pub. No.: US 2024/0283031 A1
(43) Pub. Date: Aug. 22, 2024

(54) SOLID-STATE BATTERY AND SOLID-STATE BATTERY MANUFACTURING METHOD

(71) Applicant: FDK CORPORATION, Tokyo (JP)

(72) Inventors: Yoichiro KAWANO, Tokyo (JP); Akihiro MITANI, Tokyo (JP)

(73) Assignee: FDK CORPORATION, Tokyo (JP)

(21) Appl. No.: 18/650,419

(22) Filed: Apr. 30, 2024

Related U.S. Application Data
(63) Continuation of application No. PCT/JP2022/031062, filed on Aug. 17, 2022.

(30) Foreign Application Priority Data
Dec. 28, 2021 (JP) 2021-214980

(51) Int. Cl. H01M 10/0585; H01M 10/0562; H01M 50/117; H01M 50/548; H01M 50/553

(52) U.S. Cl. CPC H01M 10/0585; H01M 10/0562; H01M 50/117; H01M 50/548; H01M 50/553

(57) ABSTRACT

A solid-state battery includes a multi-layer body, a silica-based glass material, and buffer layers. The multi-layer body includes a positive electrode layer and negative electrode layers, all of which are electrode layers, and includes solid electrolyte layers. The electrode layers and the solid electrolyte layer are alternately stacked, and for example, two of the negative electrode layers are located as the outermost layers. The silica-based glass material covers the multi-layer body. The buffer layers have an insulating property, and are formed between the outermost negative electrode layers of the multi-layer body and the silica-based glass material.

### CROSS-REFERENCE TO RELATED APPLICATION

This application is a continuation application of International Application PCT/JP2022/031062 filed on Aug. 17, 2022, which designated the U.S., which is based upon and claims the benefit of priority of the prior Japanese Patent Application No. 2021-214980, filed on Dec. 28, 2021, the entire contents of which are incorporated herein by reference.

### FIELD

The embodiment relates to a solid-state battery and a solid-state battery manufacturing method.

### BACKGROUND

There is known a solid-state battery in which solid electrolytes are used as electrolytes, instead of using electrolyte solution. Regarding such a solid-state battery, a technique for obtaining a sintered body is known. In this technique, first, positive and negative electrode layers, a solid electrolyte layer formed therebetween, and a solid electrolyte layer for covering these layers are each formed in sheet-like form or paste form by using a binder, etc. Next, these layers are stacked on top of each other in a predetermined order, and degreasing and firing are performed through thermal processes, so as to obtain a sintered body.

Conventionally, there is known a technique regarding a method for manufacturing a ceramic molded body for sintering. In this technique, raw material powder containing ceramic powder and a thermoplastic resin having a glass transition temperature higher than room temperature is molded by isostatic pressing at a temperature lower than the glass transition temperature of the thermoplastic resin. The resultant material is next heated to the glass transition temperature of the thermoplastic resin or higher, and is finally molded by hot isostatic pressing (Japanese Laid-open Patent Publication No. 2019-199078).

In addition, regarding a solid-state battery, there is known a technique for covering the surface of a battery element, in which a solid electrolyte layer is formed between positive and negative electrode layers, with a protective layer containing a polymer compound. Further, there is known a technique for covering the surface of a battery element with a protective layer containing an insulating material other than resin. Compared with use of a protective layer containing a polymer compound, use of this protective layer is less prone to cracking and detachment due to moisture and gas adsorption, and is less prone to detachment due to vibration, impact shock, or the like because this protective layer has a higher bonding strength with respect to the battery element. There is also known a technique that uses a glass or ceramic material as the insulating material (International Publication Pamphlets No. WO2020/054544 and No. WO2020/054544).

A silica-based glass material is one of the materials from which a dense and hard sintered body is obtained at a relatively low firing temperature, and is considered as a suitable material for covering a battery element, that is, a multi-layer body including positive and negative electrode layers and a solid electrolyte layer formed therebetween.

However, the silica-based glass material has a property of a relatively high reactivity with the electrode layers included in the multi-layer body which is the battery element. Therefore, if the silica-based glass material is used for a portion that is in direct contact with an electrode layer included in the multi-layer body in a relatively large area, the silica-based glass material could react with the electrode layer. As a result, battery characteristics such as the discharge or charge-discharge characteristics and mechanical strength of the solid-state battery could be deteriorated.

### SUMMARY

According to an aspect, there is provided a solid-state battery including: a multi-layer body in which at least two electrode layers and at least one solid electrolyte layer are alternately stacked and in which two of the electrode layers are located as outermost electrode layers; a silica-based glass material that covers the multi-layer body; and an insulating buffer layer that is provided between each of the outermost electrode layers of the multi-layer body and the silica-based glass material.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWING

FIGS. 1A to 1C illustrate an example of a solid-state battery;

FIGS. 2A to 2C illustrate a construction example of a solid-state battery;

FIGS. 3A to 3D illustrate an example of a solid electrolyte layer part forming process;

FIGS. 4A to 4D illustrate an example of a positive electrode layer part forming process;

FIGS. 5A to 5D illustrate an example of a negative electrode layer part forming process;

FIGS. 6A to 6D illustrate an example of a buffer layer part forming process;

FIGS. 7A and 7B illustrate an example of a structure forming process;

FIGS. 8A and 8B illustrate an example of a structure firing process and an example of an external electrode forming process;

FIGS. 9A and 9B illustrate examples of SEM images of solid-state batteries;

FIGS. 10A and 10B illustrate examples of charge and discharge curve diagrams of solid-state batteries; and

FIG. 11 schematically illustrates an example of a microscope image of a solid-state battery.

### DESCRIPTION OF EMBODIMENTS

Lithium-ion secondary batteries have greatly contributed to reduction in size and weight of devices, and applications of these batteries have been expanding to electric vehicles, stationary power storage facilities, mobile information terminals, Internet of Things (IoT) devices, wearable terminals, etc. Accordingly, needed specifications have been diversified, and expectations for higher energy density and safety are rising. As a new battery for meeting this demand, development of a solid-state battery is in progress. As one type of solid-state batteries, a solid-state battery using a solid electrolyte as an electrolyte is known. Because this solid-state battery does not use flammable organic electrolyte solution, it is possible to enhance safety while reducing the risks of liquid leakage, combustion, explosion, and generation of toxic gas. In addition, this solid-state battery is easily handled in the atmosphere, and the performance of the solid-state battery is maintained under low temperature and high temperature conditions. By using solid electrolytes, it is possible to use electrode materials that operate at a higher voltage, and therefore, further improvement in performance of the solid-state battery, such as increase in energy density, is also expected.

### [Solid-State Battery]

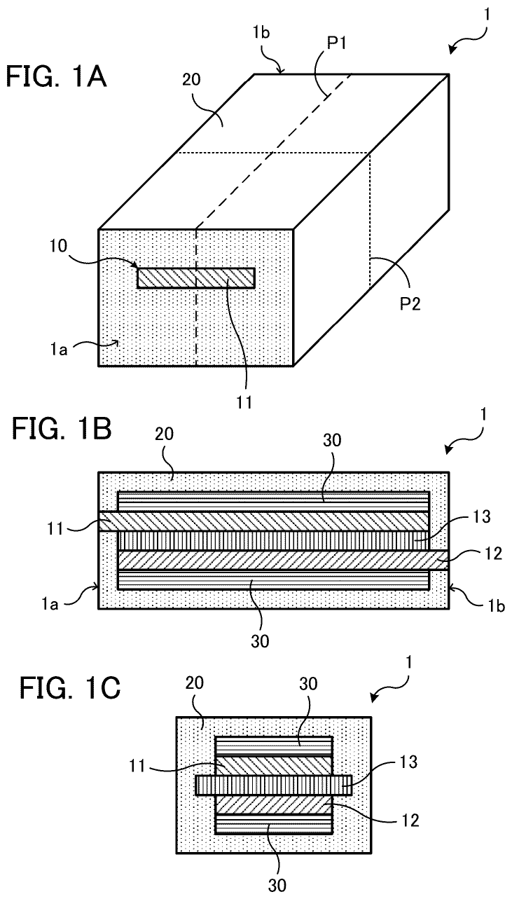

FIGS. 1A to 1C illustrate an example of a solid-state battery. FIG. 1A is a schematic perspective view of a main part of an example of a solid-state battery. FIG. 1B schematically illustrates an example of a sectional view taken along a dashed line P1 in FIG. 1A. FIG. 1C schematically illustrates an example of a sectional view taken along a dotted line P2 in FIG. 1A.

A solid-state battery 1 illustrated in FIGS. 1A to 1C is an example of a chip-type battery. The solid-state battery 1 includes a multi-layer body 10, which is a battery element (a solid-state battery body) of the solid-state battery 1, and includes a silica-based glass material 20, which functions as a coating film covering the multi-layer body 10. The solid-state battery 1 further includes buffer layers 30 formed between the multi-layer body 10 and the silica-based glass material 20 covering the multi-layer body 10.

The multi-layer body 10 includes a positive electrode layer 11 and a negative electrode layer 12, which are the electrode layers of the battery element, and includes a solid electrolyte layer 13 formed therebetween. The multi-layer body 10 illustrated in FIGS. 1A to 1C is an example of a construction in which two electrode layers of the positive electrode layer 11 and the negative electrode layer 12 and one solid electrolyte layer 13 are alternately stacked on top of each other, and the electrode layers are located as the outermost layers.

The solid electrolyte layer 13 contains a solid electrolyte. An oxide solid electrolyte may be used for the solid electrolyte layer 13. For example, LAGP, which is one type of Na super ionic conductor type (also referred to as “NASICON-type”) oxide solid electrolyte, is used for the solid electrolyte layer 13. LAGP is an oxide solid electrolyte represented by a general formula Li₁+ₓAlₓGe₂−ₓ(PO₄)₃ (0<x≤1). For example, an LAGP having a composition ratio x=0.5, that is, Li_{1.5}Al_{0.5}Ge_{1.5}(PO₄)₃, is used for the solid electrolyte layer 13. As another example, a sulfide solid electrolyte such as Li₂S (lithium sulfide)—P₂S₅ (phosphorus pentasulfide) may be used for the solid electrolyte layer 13.

The positive electrode layer 11 contains a positive electrode active material. For example, Li₂CoP₂O₇ (lithium cobalt pyrophosphate also referred to as “LCPO”) is used as the positive electrode active material of the positive electrode layer 11. The positive electrode layer 11 contains a solid electrolyte (also referred to as a first solid electrolyte) and a conductive auxiliary agent, in addition to the positive electrode active material. For example, the same kind of solid electrolyte as that used for the solid electrolyte layer 13 is used as the solid electrolyte of the positive electrode layer 11. For example, LAGP is used as the solid electrolyte of the positive electrode layer 11. As the conductive auxiliary agent of the positive electrode layer 11, for example, a carbon material such as carbon fiber, carbon black, graphite, graphene, or carbon nanotube is used.

The negative electrode layer 12 contains a negative electrode active material. For example, titanium oxide (TiO₂) is used as the negative electrode active material of the negative electrode layer 12. Alternatively, Nb₂O₅ (niobium pentoxide), Li₃V₂(PO₄)₃ (lithium vanadium phosphate), Li₄Ti₅O₁₂ (lithium titanate), or the like may be used as the negative electrode active material of the negative electrode layer 12. The negative electrode layer 12 contains a solid electrolyte (also referred to as a second solid electrolyte) and a conductive auxiliary agent, in addition to the negative electrode active material. For example, the same kind of solid electrolyte as that used for the solid electrolyte layer 13 is used as the solid electrolyte of the negative electrode layer 12. For example, LAGP is used as the solid electrolyte of the negative electrode layer 12. As the conductive auxiliary agent of the negative electrode layer 12, for example, a carbon material such as carbon fiber, carbon black, graphite, graphene, or carbon nanotube is used.

In the multi-layer body 10, the positive electrode layer 11 and the negative electrode layer 12 are formed to face each other and to partly overlap with each other via the solid electrolyte layer 13. As will be described below, one of the side surfaces of the positive electrode layer 11, the side surface not overlapping with the negative electrode layer 12, is exposed to the outside from the silica-based glass material 20 covering the multi-layer body 10 (FIGS. 1A and 1B), and one of the side surfaces of the negative electrode layer 12, the side surface not overlapping with the positive electrode layer 11, is exposed to the outside from the silica-based glass material 20 covering the multi-layer body 10 (FIG. 1B).

During charging of the multi-layer body 10, lithium ions are conducted from the positive electrode layer 11 to the negative electrode layer 12 via the solid electrolyte layer 13, and are captured by the negative electrode layer 12. During discharging of the multi-layer body 10, lithium ions are conducted from the negative electrode layer 12 to the positive electrode layer 11 via the solid electrolyte layer 13, and are captured by the positive electrode layer 11. Through this lithium ion conduction, the multi-layer body 10, which is the battery element of the solid-state battery 1, realizes its charging and discharging operations.

The silica-based glass material 20 contains SiO₂ (silicon oxide or silica). The silica-based glass material 20 may contain at least one of LiO₂ (lithium oxide), Na₂O (sodium oxide), K₂O (potassium oxide), and B₂O₃ (boron oxide), in addition to SiO₂. A ceramic material such as particulate Al₂O₃ (aluminum oxide) may be added to the silica-based glass material 20. By adding a ceramic material such as Al₂O₃ having a higher degree of hardness than the silica-based glass material 20 to the silica-based glass material 20, it is possible to increase the hardness and the mechanical strength of the silica-based glass material 20.

As illustrated in FIGS. 1A and 1B, the silica-based glass material 20 covers the multi-layer body 10 such that one of the side surfaces of the positive electrode layer 11 and one of the side surfaces of the negative electrode layer 12 of the multi-layer body 10 are exposed to the outside. The one of the side surfaces of the positive electrode layer 11 and the one of the side surfaces of the negative electrode layer 12, these side surfaces being exposed to the outside from the silica-based glass material 20, generally face each other in a direction orthogonal to the stacking direction of the solid electrolyte layer 13, the positive electrode layer 11, and the negative electrode layer 12, for example. The one of the side surfaces of the positive electrode layer 11 and the one of the side surfaces of the negative electrode layer 12, these side surfaces being exposed to the outside from the silica-based glass material 20, are used for electrically connecting the multi-layer body 10 to the outside. In the present embodiment, the solid-state battery 1 has a side surface on the same plane with the one of the side surfaces of the positive electrode layer 11, the one side surface being exposed to the outside from the silica-based glass material 20. This side surface of the solid-state battery 1 will be referred to as a positive electrode extraction surface 1a. In addition, the solid-state battery 1 has a side surface on the same plane with the one of the side surfaces of the negative electrode layer 12, the one side surface being exposed to the outside from the silica-based glass material 20. This side surface of the solid-state battery 1 will be referred to as a negative electrode extraction surface 1b.

The silica-based glass material 20 covering the multi-layer body 10 has an insulating property and a low permeation property to moisture or gas such as hydrogen and oxygen. Specifically, the silica-based glass material 20 has an insulating property such that the silica-based glass material 20 is not or little affected by the lithium-ion conduction and electronic conduction of the multi-layer body 10. Further, the silica-based glass material 20 has a higher degree of hardness than the solid electrolytes used in the solid electrolyte layer 13, the positive electrode layer 11, and the negative electrode layer 12 of the multi-layer body 10.

The silica-based glass material 20 seals the multi-layer body 10, except for the surface of the positive electrode layer 11, the surface being exposed to the outside from the positive electrode extraction surface 1a, and the surface of the negative electrode layer 12, the surface being exposed to the outside from the negative electrode extraction surface 1b, so as to protect the multi-layer body 10 from an external environment or force. For example, using the silica-based glass material 20 as a protective layer of the multi-layer body 10 further reduces occurrence of damage such as cracking or chipping due to external force, entry of moisture or gas from where cracking or chipping has occurred, and resultant deterioration of the battery characteristics of the solid-state battery 1 such as short circuit and increase in resistance, compared with a case in which a solid electrolyte is used as a protective layer.

The individual buffer layer 30 contains a solid electrolyte (also referred to as a third solid electrolyte). The solid electrolyte of the individual buffer layer 30 is, for example, the same kind of solid electrolyte as that used for the solid electrolyte layer 13. For example, LAGP is used as the solid electrolyte of the individual buffer layer 30.

The buffer layers 30 are formed between the multi-layer body 10 and the silica-based glass material 20 covering the multi-layer body 10. In this example, one buffer layer 30 is formed on the outer side of the positive electrode layer 11 of the multi-layer body 10, and the other buffer layer 30 is formed on the outer side of the negative electrode layer 12 of the multi-layer body 10. That is, one buffer layer 30 is formed between the positive electrode layer 11 of the multi-layer body 10 and the silica-based glass material 20, and the other buffer layer 30 is formed between the negative electrode layer 12 of the multi-layer body 10 and the silica-based glass material 20. The silica-based glass material 20 is formed so as to cover the multi-layer body 10 and the buffer layers 30 stacked on the outer sides of the multi-layer body 10, except for the one of the side surfaces of the positive electrode layer 11 and the one of the side surfaces of the negative electrode layer 12.

The solid-state battery 1 having the above-described construction is manufactured by the following procedure, for example.

First, a structure is formed. This structure includes: the multi-layer body 10 including the positive electrode layer 11, the negative electrode layer 12, and the solid electrolyte layer 13 formed therebetween; the silica-based glass material 20 covering the multi-layer body 10 such that the one of the side surfaces of the positive electrode layer 11 and the one of the side surfaces of the negative electrode layer 12 are exposed to the outside; and the buffer layers 30, one of which is formed between the positive electrode layer 11 and the silica-based glass material 20 and the other buffer layer 30 is formed between the negative electrode layer 12 and the silica-based glass material 20. The positive electrode layer 11, the negative electrode layer 12, the solid electrolyte layer 13, the silica-based glass material 20, and the buffer layers 30 of this structure are each prepared as paste formed by mixing powder of active material, solid electrolyte, etc., which are used for exhibiting a predetermined function, with an organic binder or the like, or are each prepared as a sheet formed by applying such paste onto a support such as a polyethylene terephthalate (PET) film. The paste or sheet of each layer described above is first applied or stacked on top of each other in a predetermined order, and the resultant layers are next cut as needed to obtain the structure.

The obtained structure is fired at a predetermined temperature. The firing includes firing for degreasing (also referred to as desolvation) in which organic components such as a binder contained in each layer of the structure are burned off, and includes firing for sintering in which particles of the powder of each layer are bonded or grown. The organic components such as a binder are burned off by the degreasing, and the particles are bonded or grown by the sintering such that the voids formed by the burning are filled. As a result, each layer of the structure is densified. The solid-state battery 1 is manufactured by performing the above-described firing on the structure.

In the solid-state battery 1, as described above, one buffer layer 30 containing a solid electrolyte is formed between the positive electrode layer 11 of the multi-layer body 10 and the silica-based glass material 20, and the other buffer layer 30 is formed between the negative electrode layer 12 of the multi-layer body 10 and the silica-based glass material 20. In this way, deterioration in battery characteristics of the solid-state battery 1 is reduced.

That is, although the silica-based glass material 20 has a function of protecting the multi-layer body 10 from an external environment or force, the silica-based glass material 20 has a property of a relatively high reactivity with the electrode layers such as the positive electrode layer 11 and the negative electrode layer 12 during the firing as described above. For example, due to the reaction between the electrode layers and the silica-based glass material 20 during the firing, diffusion of heterogeneous elements between the electrode layers and the silica-based glass material 20 and insufficient sintering, which occurs as a result of the diffusion, are relatively easily caused. This could deteriorate the utilization rate of the active material in any one of the electrode layers. Therefore, if the silica-based glass material 20 is in direct contact with an electrode layer in a relatively large area, battery characteristics such as charge-discharge characteristics and mechanical strength could be deteriorated due to the reaction between the electrode layer and the silica-based glass material 20 during the firing.

However, in the solid-state batteries 1 as illustrated in FIGS. 1A to 1C, one of the buffer layers 30 containing a solid electrolyte is formed between an electrode layer (the positive electrode layer 11) and the silica-based glass material 20, and the other buffer layer 30 is formed between an electrode layer (the negative electrode layer 12) and the silica-based glass material 20. This construction reduces the areas where the individual electrode layers are in direct contact with the silica-based glass material 20. As a result, the reaction between the individual electrode layers and the silica-based glass material 20 is reduced, and thus, deterioration in battery characteristics such as the charge-discharge characteristics and the mechanical strength due to the reaction is reduced.

By forming the buffer layers 30 between the multi-layer body 10, which includes the positive electrode layer 11, the negative electrode layer 12, and the solid electrolyte layer 13 formed therebetween, and the silica-based glass material 20, which covers the multi-layer body 10, the solid-state battery 1 exhibiting excellent battery characteristics is realized.

### [Construction Example of Solid-State Battery]

Next, a construction example of a solid-state battery will be described.

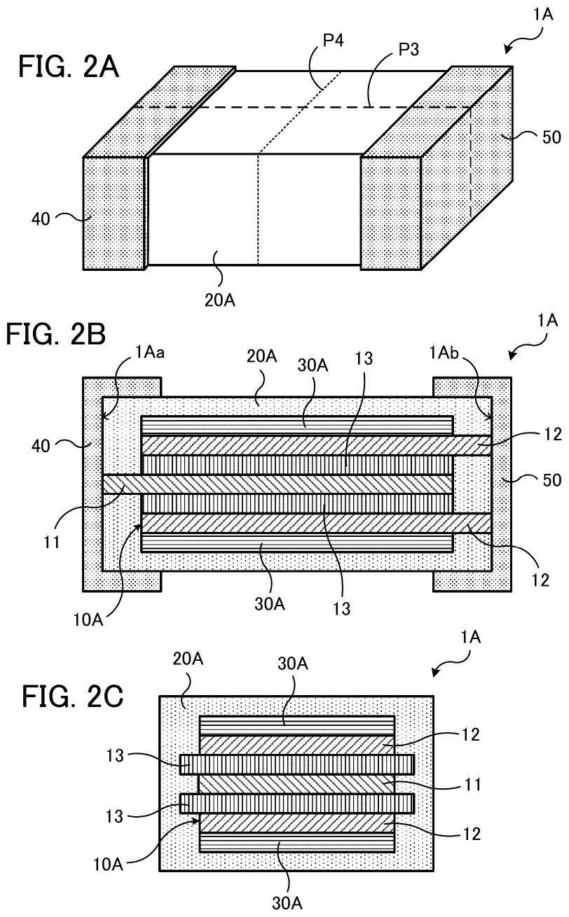

FIGS. 2A to 2C illustrate a construction example of a solid-state battery. FIG. 2A is a schematic perspective view of a main part of an example of a solid-state battery. FIG. 2B schematically illustrates an example of a sectional view taken along a dashed line P3 in FIG. 2A. FIG. 2C schematically illustrates an example of a sectional view taken along a dotted line P4 in FIG. 2A.

A solid-state battery 1A illustrated in FIGS. 2A to 2C is an example of a chip-type battery. The solid-state battery 1A includes a multi-layer body 10A, a silica-based glass material 20A, buffer layers 30A, an external electrode 40, and an external electrode 50.

As illustrated in FIGS. 2B and 2C, the multi-layer body 10A includes solid electrolyte layers 13, a positive electrode layer 11 (an electrode layer), and negative electrode layers 12 (electric layers). The solid electrolyte layers 13, the positive electrode layer 11, and the negative electrode layers 12 of the multi-layer body 10A are stacked on top of each other such that a pair of a positive electrode layer 11 and a negative electrode layer 12 are formed to face each other via one solid electrolyte layer 13. That is, the multi-layer body 10A illustrated in this example has a construction in which one negative electrode layer 12, one solid electrolyte layer 13, the positive electrode layer 11, the other solid electrolyte layer 13, and the other negative electrode layer 12 are stacked on top of each other in this order from the bottom. In the multi-layer body 10A, a pair of a positive electrode layer 11 and a negative electrode layer 12 facing each other via a solid electrolyte layer 13 are formed to partly overlap with each other via the solid electrolyte layer 13. The multi-layer body 10A is an example of a multi-layer body in which at least two electrode layers (the positive electrode layer 11 and the negative electrode layers 12) and at least one solid electrolyte layer (the solid electrolyte layers 13) are alternately stacked, and in which the electrode layers (the negative electrode layers 12) are located as the outermost layers.

In the present embodiment, the multi-layer body 10A including one positive electrode layer 11, two negative electrode layers 12, and two solid electrolyte layers 13 stacked alternately with the positive electrode layer 11 and the negative electrode layers 12 is used as an example. However, the number of positive electrode layers 11, negative electrode layers 12, and solid electrolyte layers 13 is not limited to this example.

The individual solid electrolyte layer 13 of the multi-layer body 10A contains, for example, LAGP, which is an oxide solid electrolyte. The positive electrode layer 11 of the multi-layer body 10A contains, for example, LCPO, which is a positive electrode active material, LAGP, which is an oxide solid electrolyte, and a carbon material as a conductive auxiliary agent. The individual negative electrode layer 12 of the multi-layer body 10A contains, for example, anatase-type TiO₂, which is a negative electrode active material, LAGP, which is an oxide solid electrolyte, and a carbon material as a conductive auxiliary agent.

During charging of the multi-layer body 10A, lithium ions are conducted from the positive electrode layer 11 to the negative electrode layers 12 via the solid electrolyte layers 13, and are captured by the negative electrode layers 12. During discharging of the multi-layer body 10A, lithium ions are conducted from the negative electrode layers 12 to the positive electrode layer 11 via the solid electrolyte layers 13, and are captured by the positive electrode layer 11. The multi-layer body 10A realizes its charging and discharging operations through this lithium-ion conduction based on an individual pair of a positive electrode layer 11 and a negative electrode layer 12 facing each other and a solid electrolyte layer 13 formed therebetween.

As illustrated in FIG. 2B, the silica-based glass material 20A covers the multi-layer body 10A such that one of the side surfaces of the positive electrode layer 11 and one of the side surfaces of each of the negative electrode layers 12 of the multi-layer body 10A are exposed to the outside. The solid-state battery 1A has a side surface on the same plane with the one of the side surfaces of the positive electrode layer 11, the one side surface being exposed from the silica-based glass material 20A. This one side surface of the solid-state battery 1A will be referred to as a positive electrode extraction surface 1Aa. In addition, the solid-state battery 1A has a side surface on the same plane with the one of the side surfaces of each of the negative electrode layers 12, these side surfaces being exposed from the silica-based glass material 20A. This side surface of the solid-state battery 1A will be referred to as a negative electrode extraction surface 1Ab.

The silica-based glass material 20A covering the multi-layer 10A contains SiO₂. The silica-based glass material 20A may contain at least one of LiO₂, Na₂O, K₂O, and B₂O₃, in addition to SiO₂. A ceramic material such as particulate Al₂O₃ may be added to the silica-based glass material 20A. The silica-based glass material 20A has an insulating property and a low permeation property to moisture or gas such as hydrogen or oxygen. Further, the silica-based glass material 20A has a higher degree of hardness than the solid electrolyte used in the solid electrolyte layers 13, the positive electrode layer 11, and the negative electrode layers 12.

The buffer layers 30A are formed between the multi-layer body 10A and the silica-based glass material 20A covering the multi-layer body 10A. In this example, an individual buffer layer 30A is formed on the outer side of each of the two negative electrode layers 12, which are the outermost electrode layers of the multi-layer body 10A. That is, a buffer layer 30A is formed between each negative electrode layer 12 of the multi-layer body 10A and the silica-based glass material 20A. For example, the buffer layers 30A are formed on the outer sides of the two negative electrode layers 12 located as the outermost layers of the multi-layer body 10A such that the buffer layers 30A overlap with the solid electrolyte layers 13 via the negative electrode layers 12. The silica-based glass material 20A is formed so as to cover the multi-layer body 10A and the buffer layers 30A further stacked on the outer sides of the negative electrode layers 12 of the multi-layer body 10A, except for the one of the side surfaces of the positive electrode layer 11, the side surface being exposed to the outside from the positive electrode extraction surface 1Aa, and one of the side surfaces of each of the negative electrode layers 12, these side surfaces being exposed to the outside from the negative electrode extraction surface 1Ab. For example, LAGP, which is an oxide solid electrolyte, is used for the individual buffer layer 30A.

As illustrated in FIG. 2B, the external electrode 40 is formed on the positive electrode extraction surface 1Aa of the solid-state battery 1A, and is connected to the one of the side surfaces of the positive electrode layer 11 of the multi-layer body 10A, the side surface being exposed to the outside from the positive electrode extraction surface 1Aa. As illustrated in FIG. 2B, the external electrode 50 is formed on the negative electrode extraction surface 1Ab of the solid-state battery 1A, and is connected to the one of the side surfaces of each of the negative electrode layers 12 of the multi-layer body 10A, these side surfaces being exposed to the outside from the negative electrode extraction surface 1Ab. Any one of various conductive materials may be used for the external electrode 40 and the external electrode 50. For example, the external electrode 40 and the external electrode 50 are formed by drying and curing conductive paste containing metal particles such as silver (Ag) or conductive particles such as carbon particles or by depositing various kinds of metal through sputtering, plating, or the like.

As described above, in the solid-state battery 1A, the individual buffer layer 30A using a solid electrolyte is formed between each outermost negative electrode layer 12 of the multi-layer body 10A and the silica-based glass material 20A covering the multi-layer body 10A. This construction reduces the contact area between the individual negative electrode layer 12 and the silica-based glass material 20A, and reduces the reaction between the individual negative electrode layer 12 and the silica-based glass material 20A during the firing performed in a manufacturing process, which will be described below. Consequently, resultant diffusion of heterogeneous elements, insufficient sintering, and decrease in the utilization rate of the negative electrode active material are reduced. As a result, deterioration in charge-discharge characteristics and mechanical strength of the solid-state battery 1A is reduced. In the solid-state battery 1A, the multi-layer body 10A and the buffer layers 30A are covered with the silica-based glass material 20A as a protective layer. This construction reduces occurrence of damage such as cracking or chipping due to external force, entry of moisture or gas from where cracking or chipping has occurred, and resultant deterioration of the battery characteristics of the solid-state battery 1A such as short circuit and increase in resistance. This construction in which the buffer layers 30A are formed between the multi-layer body 10A and the silica-based glass material 20A realizes the solid-state battery 1A, which includes the silica-based glass material 20A as a protective layer and which exhibits excellent battery characteristics.

### [Solid-State Battery Manufacturing Method]

Next, a solid-state battery manufacturing method will be described.

### (LAGP Powder)

First, powders of Li₂CO₃ (lithium carbonate), Al₂O₃, GeO₂ (germanium oxide), and NH₄H₂PO₄ (ammonium dihydrogen phosphate), which are raw materials for LAGP, are weighed so as to have a predetermined composition ratio, and mixed in a magnetic mortar or a ball mill. The mixture obtained by the mixing is put into an alumina crucible or the like, and is fired at a temperature of 300° C. to 400° C. for 3 to 5 hours. The powder obtained by this pre-firing is melted through a thermal process at a temperature of 1200° C. to 1400° C. for 1 to 2 hours. The material obtained by the melting is quenched and vitrified. As a result, amorphous LAGP powder is formed. Crystalline LAGP powder may be formed alternatively.

The obtained LAGP powder (amorphous powder or crystalline powder or both amorphous powder and crystalline powder) is coarsely crushed such that the particle diameter will be 200 μm or less, and is further pulverized by using a pulverizer such as a ball mill such that the particle diameter will be adjusted to a target particle diameter p (median diameter D50). The particle diameter p of the LAGP powder for the electrolyte layers and the buffer layers is adjusted to, for example, 2 μm≤p≤5 μm. As to the electrode layers, the LAGP powder needs to be interposed among the particles of the powdered active material to obtain the lithium-ion conductivity. Thus, the particle diameter p is adjusted to be less than that of the electrolyte layers. For example, the particle diameter p is adjusted to 0.2 μm≤p≤1.0 μm.

For example, in accordance with the method as described above, the LAGP powders used for the solid electrolyte layers 13, the positive electrode layer 11 and the negative electrode layers 12, which are the electrodes layers, and the buffer layers 30A of the solid-state battery 1A are prepared.

### (Solid Electrolyte Paste)

A solid electrolyte is mixed with a binder, plasticizer, dispersant, diluent, and the like to prepare solid electrolyte paste. The amount of each component of the solid electrolyte paste is adjusted as appropriate. For example, the solid electrolyte paste is prepared by using LAGP, which is an oxide solid electrolyte, as the solid electrolyte.

### (Positive Electrode Paste)

A positive electrode active material, solid electrolyte, and conductive auxiliary agent are mixed with a binder, plasticizer, dispersant, diluent, and the like to prepare positive electrode paste. The amount of each component of the positive electrode paste is adjusted as appropriate. For example, the positive electrode paste is prepared by using LCPO as the positive electrode active material, LAGP, which is an oxide solid electrolyte, as the solid electrolyte, and a carbon material as the conductive auxiliary agent.

### (Negative Electrode Paste)

A negative electrode active material, solid electrolyte, and conductive auxiliary agent are mixed with a binder, plasticizer, dispersant, diluent, and the like to prepare negative electrode paste. The amount of each component of the negative electrode paste is adjusted as appropriate. For example, the negative electrode paste is prepared by using anatase-type TiO₂ as the negative electrode active material, LAGP, which is an oxide solid electrolyte, as the solid electrolyte, and a carbon material as the conductive auxiliary agent.

### (Silica-Based Glass Material Paste)

Silica-based glass powder containing an SiO₂ glass component is prepared. The glass component of the silica-based glass powder may contain at least one of LiO₂, Na₂O, K₂O, and B₂O₃, in addition to SiO₂. The silica-based glass powder is mixed with a binder, plasticizer, dispersant, diluent, and the like to prepare silica-based glass material paste. The amount of each component of the silica-based glass material paste is adjusted as appropriate. A ceramic material such as particulate Al₂O₃ may be added to the silica-based glass material paste.

The solid electrolyte paste, the positive electrode paste, the negative electrode paste, and the silica-based glass material paste as described above are used to manufacture the solid-state battery 1A.

### (Forming of Solid Electrolyte Layer Part)

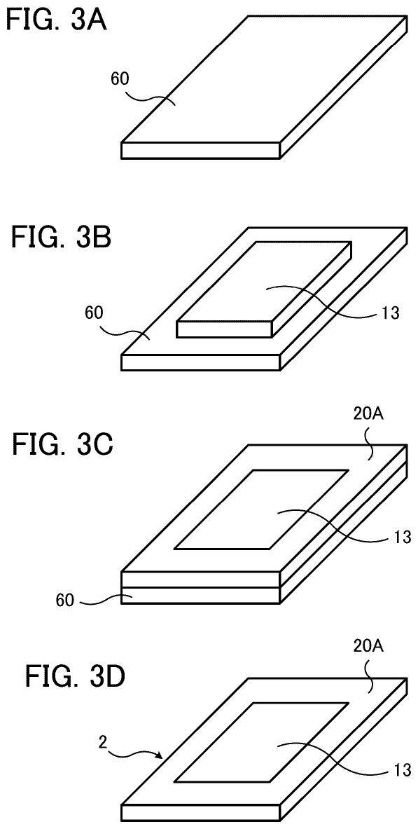

FIGS. 3A to 3D illustrate an example of a solid electrolyte layer part forming process. FIG. 3A is a schematic perspective view of a main part of an example of a support preparation process. FIG. 3B is a schematic perspective view of a main part of an example of a solid electrolyte layer forming process. FIG. 3C is a schematic perspective view of a main part of an example of a silica-based glass material forming process. FIG. 3D is a schematic perspective view of a main part of an example of a support separation process.

For example, a PET film is used as a support 60 illustrated in FIG. 3A. As illustrated in FIG. 3B, a solid electrolyte layer 13 is formed by coating a part on the support 60 with solid electrolyte paste such that the solid electrolyte paste has a predetermined thickness. Next, the solid electrolyte paste is dried under predetermined conditions to remove the solvent components. The part on the support 60 may be coated with the solid electrolyte paste once or a plurality of times. The solid electrolyte paste may be dried each time the coating is performed or all at once after the coating is performed a plurality of times.

After the solid electrolyte layer 13 is formed on the part on the support 60, a silica-based glass material 20A is formed by coating the peripheral area of the solid electrolyte layer 13 on the support 60 with silica-based glass material paste as illustrated in FIG. 3C. Next, the silica-based glass material paste is dried under predetermined conditions to remove the solvent components. The peripheral area of the solid electrolyte layer 13 on the support 60 may be coated with the silica-based glass material paste once or a plurality of times. The silica-based glass material paste may be dried each time the coating is performed or all at once after the coating is performed a plurality of times.

After the solid electrolyte layer 13 and the silica-based glass material 20A are formed on the support 60, the support 60 is separated therefrom. In this way, a solid electrolyte layer part 2 as illustrated in FIG. 3D is formed.

### (Forming of Positive Electrode Layer Part)

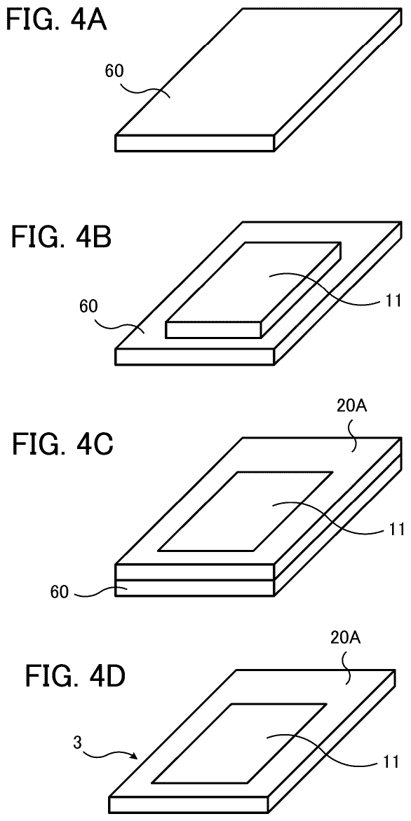

FIGS. 4A to 4D illustrate an example of a positive electrode layer part forming process. FIG. 4A is a schematic perspective view of a main part of an example of a support preparation process. FIG. 4B is a schematic perspective view of a main part of an example of a positive electrode layer forming process. FIG. 4C is a schematic perspective view of a main part of an example of a silica-based glass material forming process. FIG. 4D is a schematic perspective view of a main part of an example of a support separation process.

A positive electrode layer 11 is formed by coating a part on a support 60, which is a PET film or the like as illustrated in FIG. 4A, with positive electrode paste as illustrated in FIG. 4B such that the positive electrode paste has a predetermined thickness and a predetermined positive electrode active material amount. Next, the positive electrode paste is dried under predetermined conditions to remove the solvent components. The part on the support 60 may be coated with the positive electrode paste once or a plurality of times. The positive electrode paste may be dried each time the coating is performed or all at once after the coating is performed a plurality of times.

After the positive electrode layer 11 is formed on the part on the support 60, a silica-based glass material 20A is formed by coating the peripheral area of the positive electrode layer 11 on the support 60 with silica-based glass material paste as illustrated in FIG. 4C. Next, the silica-based glass material paste is dried under predetermined conditions to remove the solvent components. The peripheral area of the positive electrode layer 11 on the support 60 may be coated with the silica-based glass material paste once or a plurality of times. The silica-based glass material paste may be dried each time the coating is performed or all at once after the coating is performed a plurality of times.

After the positive electrode layer 11 and the silica-based glass material 20A are formed on the support 60, the support 60 is separated therefrom. In this way, a positive electrode layer part 3 as illustrated in FIG. 4D is formed.

### (Forming of Negative Electrode Layer Part)

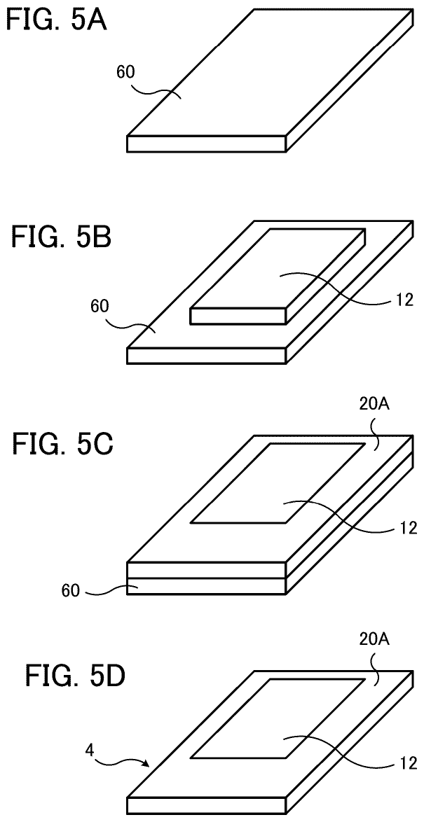

FIGS. 5A to 5D illustrate an example of a negative electrode part forming process. FIG. 5A is a schematic perspective view of a main part of an example of a support preparation process. FIG. 5B is a schematic perspective view of a main part of an example of a negative electrode layer forming process. FIG. 5C is a schematic perspective view of a main part of an example of a silica-based glass material forming process. FIG. 5D is a schematic perspective view of a main part of an example of a support separation process.

A negative electrode layer 12 is formed by coating a part on a support 60, which is a PET film or the like as illustrated in FIG. 5A, with negative electrode paste as illustrated in FIG. 5B such that the negative electrode paste has a predetermined thickness and a predetermined negative electrode paste active material amount. Next, the negative electrode paste is dried under predetermined conditions to remove the solvent components. The part on the support 60 may be coated with the negative electrode paste once or a plurality of times. The negative electrode paste may be dried each time the coating is performed or all at once after the coating is performed a plurality of times.

After the negative electrode layer 12 is formed on the part on the support 60, a silica-based glass material 20A is formed by coating the peripheral area of the negative electrode layer 12 on the support 60 with silica-based glass material paste as illustrated in FIG. 5C. Next, the silica-based glass material paste is dried under predetermined conditions to remove the solvent components. The peripheral area of the negative electrode layer 12 on the support 60 may be coated with the silica-based glass material paste once or a plurality of times. The silica-based glass material paste may be dried each time the coating is performed or all at once after the coating is performed a plurality of times.

After the negative electrode layer 12 and the silica-based glass material 20A are formed on the support 60, the support 60 is separated therefrom. In this way, a negative electrode layer part 4 as illustrated in FIG. 5D is formed.

### (Forming of Buffer Layer Part)

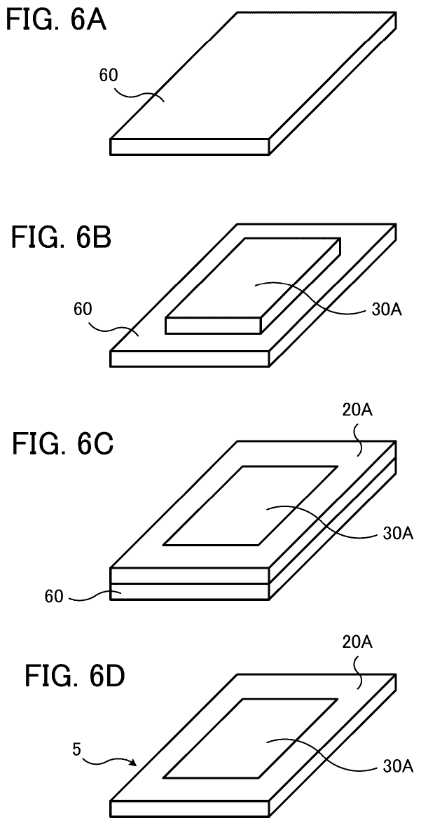

FIGS. 6A to 6D illustrate an example of a buffer layer part forming process. FIG. 6A is a schematic perspective view of a main part of an example of a support preparation process. FIG. 6B is a schematic perspective view of a main part of an example of a buffer layer forming process. FIG. 6C is a schematic perspective view of a main part of an example of a silica-based glass material forming process. FIG. 6D is a schematic perspective view of a main part of an example of a support separation process.

As illustrated in FIG. 6B, a buffer layer 30A is formed by coating a part on a support 60, which is a PET film or the like as illustrated in FIG. 6A, with solid electrolyte paste such that the solid electrolyte paste has a predetermined thickness. Next, the solid electrolyte paste is dried under predetermined conditions to remove the solvent components. The part on the support 60 may be coated with the solid electrolyte paste once or a plurality of times. The solid electrolyte paste may be dried each time the coating is performed or all at once after the coating is performed a plurality of times.

After the buffer layer 30A is formed on the part on the support 60, a silica-based glass material 20A is formed by coating the peripheral area of the buffer layer 30A on the support 60 with silica-based glass material paste as illustrated in FIG. 6C. Next, the silica-based glass material paste is dried under predetermined conditions to remove the solvent components. The peripheral area of the buffer layer 30A on the support 60 may be coated with the silica-based glass material paste once or a plurality of times. The silica-based glass material paste may be dried each time the coating is performed or all at once after the coating is performed a plurality of times.

After the buffer layer 30A and the silica-based glass material 20A are formed on the support 60, the support 60 is separated therefrom. In this way, a buffer layer part 5 as illustrated in FIG. 6D is formed.

### (Forming of Sheet-Like Silica-Based Glass Material)

A sheet-like silica-based glass material 20A is formed by coating a support, which is a PET film or the like, with silica-based glass material paste such that the silica-based glass material paste has a predetermined thickness. Next, the silica-based glass material paste is dried under predetermined conditions to remove the solvent components. The support may be coated with the silica-based glass material paste once or a plurality of times. The silica-based glass material paste may be dried each time the coating is performed or all at once after the coating is performed a plurality of times.

### (Forming of Structure)

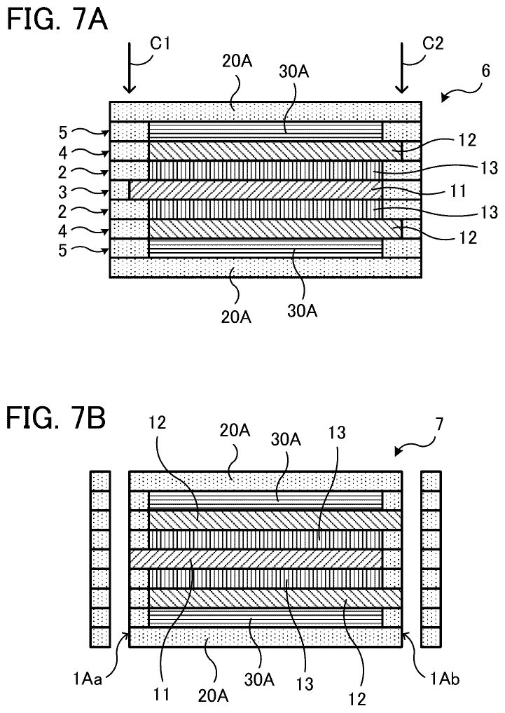

FIGS. 7A and 7B illustrate an example of a structure forming process. FIG. 7A is a schematic sectional view of a main part of an example of a process for stacking solid electrolyte layer parts, a positive electrode layer part, negative electrode layer parts, a buffer layer parts, and sheet-like silica-based glass materials on top of each other. FIG. 7B is a schematic sectional view of a main part of an example of a cutting process.

After solid electrolyte layer parts 2, a positive electrode layer part 3, negative electrode layer parts 4, buffer layer parts 5, and sheet-like silica-based glass materials 20A as described above are prepared, these are stacked in a predetermined order as illustrated in FIG. 7A, and a structure 6 is consequently formed. In this example, the structure 6 is formed by stacking one sheet-like silica-based glass material 20A, one buffer layer part 5, one negative electrode layer part 4, one solid electrolyte layer part 2, one positive electrode layer part 3, the other solid electrolyte layer part 2, the other negative electrode layer part 4, the other buffer layer part 5, and the other sheet-like silica-based glass material 20A on top of each other in this order from the bottom. The structure 6 is thermally compressed under predetermined pressure and temperature conditions. In the stacking process illustrated in FIG. 7A, the solid electrolyte layers 13, the positive electrode layer 11, the negative electrode layers 12, and the buffer layers 30A included in the structure 6 are all entirely covered with the silica-based glass material 20A without being exposed to the outside from the silica-based glass material 20A.

The structure 6 is cut at predetermined locations C1 and C2 as illustrated in FIG. 7A. The location C1 is set such that one of the side surfaces of the positive electrode layer 11 is exposed to one cut surface from the silica-based glass material 20A, and the location C2 is set such that one of the side surfaces of each of the negative electrode layers 12 is exposed to the other cut surface from the silica-based glass material 20A. In this cutting, part of the positive electrode layer 11 and part of each of the negative electrode layers 12 may be cut. By performing the cutting at the location C1 and the location C2, a structure 7 in which one of the side surfaces of the positive electrode layers 11 and one of the side surfaces of each of the negative electrode layers 12 are each exposed to a corresponding one of the cut surfaces from the silica-based glass material 20A is formed as illustrated in FIG. 7B. In the structure 7, the cut surface where the one of the side surfaces of the positive electrode layer 11 is exposed to the outside from the silica-based glass material 20A is the positive electrode extraction surface 1Aa. The cut surface where the one of the side surfaces of each of the negative electrode layers 12 is exposed to the outside from the silica-based glass material 20A is the negative electrode extraction surface 1Ab.

In this example, the solid electrolyte layer parts 2, the positive electrode layer part 3, the negative electrode layer parts 4, the buffer layer parts 5, and the sheet-like silica-based glass materials 20A are prepared in advance, are stacked on top of each other in a predetermined order, and are thermally compressed to obtain the structure 6. Next, the structure 6 is cut at the predetermined locations to obtain the structure 7. However, the method for obtaining the structure 7 is not limited to the above-described example method.

For example, one sheet-like silica-based glass material 20A is formed on a support 60 by using silica-based glass material paste. Next, a layer corresponding to one buffer layer part 5 is formed, by forming a buffer layer 30A on a part on the sheet-like silica-based glass material 20A by using solid electrolyte paste and by forming a silica-based glass material 20A on the peripheral area of the buffer layer 30A by using silica-based glass material paste. Next, a layer corresponding to one negative electrode layer part 4 is formed, by forming a negative electrode layer 12 on a part on the layer formed as described above by using negative electrode paste and by forming a silica-based glass material 20A on the peripheral area of the negative electrode layer 12 by using silica glass material paste. Next, a layer corresponding to one solid electrolyte layer part 2 is formed, by forming a solid electrolyte layer 13 on a part on the layer formed as described above by using solid electrolyte paste and by forming a silica-based glass material 20A on the peripheral area of the solid electrolyte layer 13 by using silica glass material paste. Next, a layer corresponding to the positive electrode layer part 3 is formed, by forming a positive electrode layer 11 on a part on the layer formed as described above by using positive electrode paste and by forming a silica-based glass material 20A on the peripheral area of the positive electrode layer 11 by using silica glass material paste. In the same way, the other upper layers corresponding to the other solid electrolyte layer part 2, the other negative electrode layer part 4, and the other buffer layer part 5 are formed, and the other sheet-like silica-based glass material 20A is formed as the uppermost layer. In this way, the structure 6 as illustrated in FIG. 7A is obtained. The structure 6 obtained as described above is cut at the predetermined locations to obtain the structure 7. For example, the structure 7 may be obtained in accordance with the method described above.

### (Firing of Structure and Forming of External Electrodes)

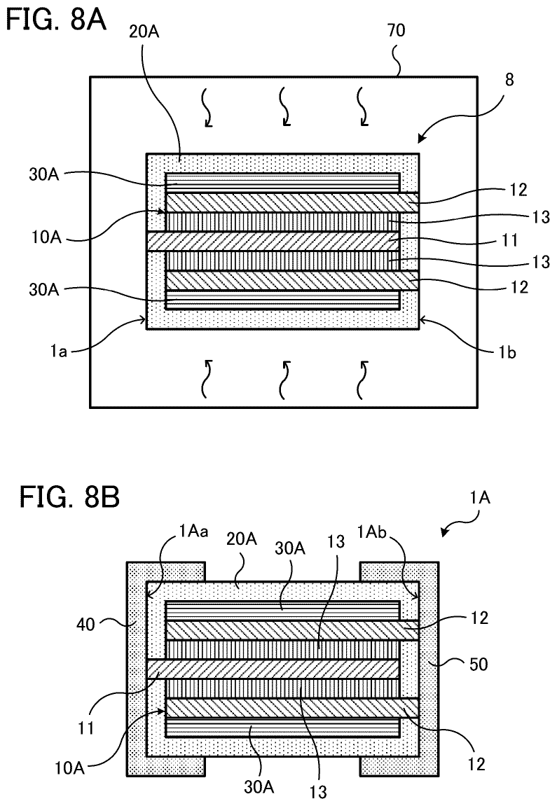

FIGS. 8A and 8B illustrate examples of a structure firing process and an external electrode forming process. FIG. 8A is a schematic sectional view of a main part of an example of a structure firing process. FIG. 8B is a schematic sectional view of a main part of an example of an external electrode forming process.

As illustrated in FIG. 8A, the structure 7 obtained by the cutting is first transferred to a firing furnace 70 and is next fired under predetermined atmosphere, temperature, and time conditions. For example, the structure 7 transferred to the firing furnace 70 is fired for degreasing, which is mainly to burn off the organic components such as the binder, and is fired for sintering, which is mainly to sinter the solid electrolyte, the positive and negative electrode active materials, and the silica-based glass material. For example, in the thermal process, the degreasing is performed by heating at 500° C. for 7 hours in an air atmosphere, and the sintering is performed by heating at 600° C. to 625° C. for 2 hours in a nitrogen atmosphere. The organic components such as the binder in the structure 7 are burned off by the degreasing, and the particles of the solid electrolyte, the positive and negative electrode active materials, and the silica-based glass material are bonded or grown by the sintering such that the voids formed by the burning are filled. As a result, each layer in the structure 7 is densified.

The solid electrolytes in the solid electrolyte layers 13 and the buffer layers 30A are sintered by the firing (the firing for degreasing and the subsequent firing for sintering). In addition, the solid electrolytes and the positive and negative electrode active materials in the positive electrode layer 11 and the negative electrode layers 12 are sintered. In this way, a multi-layer body 10A, which includes an individual pair of a positive electrode layer 11 and a negative electrode layer 12, and a solid electrolyte layer 13 formed therebetween, and buffer layers 30A, which are stacked on the outer sides of the negative electrode layers 12 located as the uppermost layer and the lowermost layer of the multi-layer body 10A, are formed as illustrated in FIG. 8A. Further, the silica-based glass materials 20A are sintered and integrated by the firing. Thus, as illustrated in FIG. 8A, a structure 8, in which the multi-layer body 10A and the buffer layers 30A are covered with the silica-based glass material 20A, is obtained.

After the structure 8 is formed, an external electrode 40 and an external electrode 50 are formed on the positive electrode extraction surface 1Aa and the negative electrode extraction surface 1Ab of the structure 8, respectively, as illustrated in FIG. 8B. For example, the external electrode 40 and the external electrode 50 are formed on the positive electrode extraction surface 1Aa and the negative electrode extraction surface 1Ab of the structure 8, respectively, by applying and firing Ag paste or the like. Other than Ag paste, conductive paste containing conductive particles such as various kinds of metal particles or carbon particles may also be used for the external electrode 40 and the external electrode 50. The external electrode 40 and the external electrode 50 may be formed by depositing various kinds of metal through sputtering, plating, or the like. The external electrode 40 and the external electrode 50 may be formed by depositing various kinds of metal through sputtering, plating, or the like after applying and firing conductive paste containing Ag or the like.

By performing the processes as described above, a solid-state battery 1A having the construction as illustrated in FIG. 8B (and FIGS. 2A to 2C) is manufactured.

### [Characteristics of Solid-State Battery]

Next, evaluation results of characteristics of solid-state batteries will be described.

### (Sinterability Evaluation)

The cross section of the solid-state battery 1A (FIGS. 2A to 2C and FIG. 8B) in which a buffer layer 30A was formed between each negative electrode layer 12 of the multi-layer body 10A and the silica-based glass material 20A covering the multi-layer body 10A was observed with a scanning electron microscopy (SEM). For comparison, a solid-state battery in which no buffer layer 30A was formed between each negative electrode layer 12 of the multi-layer body 10A and the silica-based glass material 20A covering the multi-layer body 10A was manufactured, and the cross section thereof was observed with the SEM.

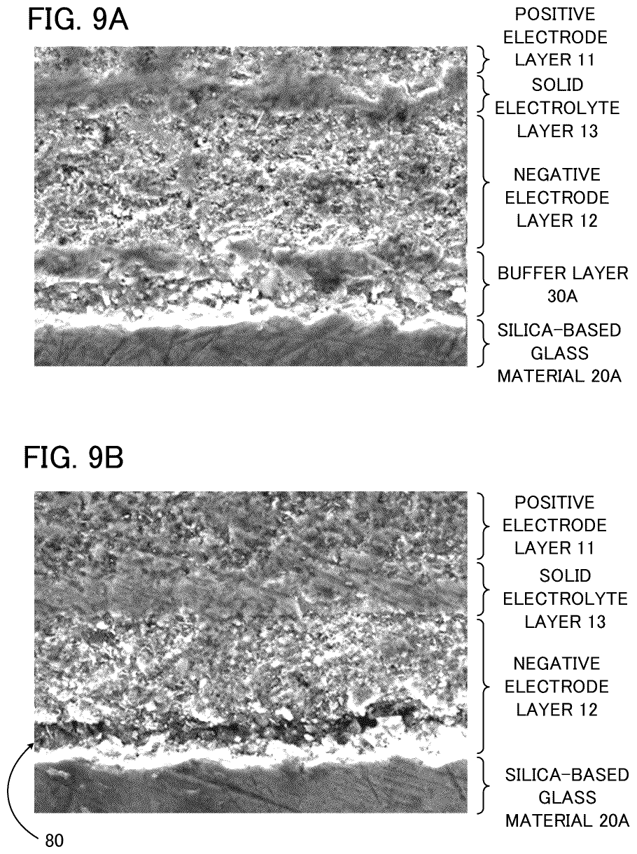

FIGS. 9A and 9B illustrate the results of the observations with the SEM. FIGS. 9A and 9B illustrate examples of SEM images of the solid-state batteries. FIG. 9A illustrates an example of an SEM image of the solid-state battery in which the buffer layers are formed. FIG. 9B illustrates an example of an SEM image of the solid-state battery in which no buffer layers are formed.

In the above-described solid-state battery 1A, the buffer layers 30A are formed between the outermost negative electrode layers 12, each of which faces the positive electrode layer 11 via a solid electrolyte layer 13, and the silica-based glass material 20A. As illustrated in FIG. 9A, in this solid-state battery 1A, a layer insufficiently sintered due to diffusion of heterogeneous elements was formed between the silica-based glass material 20A and a buffer layer 30A. This insufficiently sintered layer could cause decrease in the utilization rate of the negative electrode active material. In contrast, as illustrated in FIG. 9B, in the solid-state battery in which no buffer layers 30A were formed, a large layer insufficiently sintered due to diffusion of heterogeneous elements was formed between the silica-based glass material 20A and a negative electrode layer 12, and a loss 80 of part of the negative electrode layer 12 was observed. From the results illustrated in FIGS. 9A and 9B, it is seen that, by forming a buffer layer 30A between the silica-based glass material 20A and each negative electrode layer 12, the reaction between the silica-based glass material 20A and the negative electrode layers 12, the diffusion of heterogeneous elements therebetween, and the resultant formation of insufficiently sintered layers are reduced by the buffer layers 30A, and thus, it is possible to effectively reduce the decrease in the utilization rate of the negative electrode active materials in the negative electrode layers 12.

### (Charge and Discharge Evaluation)

A solid-state battery 1A was prepared for charge and discharge evaluation. This solid-state battery 1A included a multi-layer body 10A in which a positive electrode layer 11, solid electrolyte layers 13, and negative electrode layers 12 were stacked on top of each other in five parallel rows, and a buffer layer 30A was formed between each outermost negative electrode layer 12 of the multi-layer body 10A and a silica-based glass material 20A. A charge and discharge measurement was conducted on the solid-state battery 1A having the above-described construction under the following conditions. In addition, another solid-state battery was prepared for comparison. This solid-state battery also included a multi-layer body 10A in which a positive electrode layer 11, solid electrolyte layers 13, and negative electrode layers 12 were stacked on top of each other in five parallel rows, but no buffer layer 30A was formed between each outermost negative electrode layer 12 of the multi-layer body 10A and a silica-based glass material 20A. A charge and discharge measurement was conducted on this solid-state battery under the following conditions.

The following conditions were used for the charge and discharge measurements. The charging was conducted as constant current (CC) charging, and the end voltage was set to 3.6 V. A current value of 10 μA was set for both charging and discharging. The discharging was conducted as CC discharging, and the end voltage was set to 0 V. The charge and discharge measurements were performed in three cycles in a thermostatic chamber at 20° C.

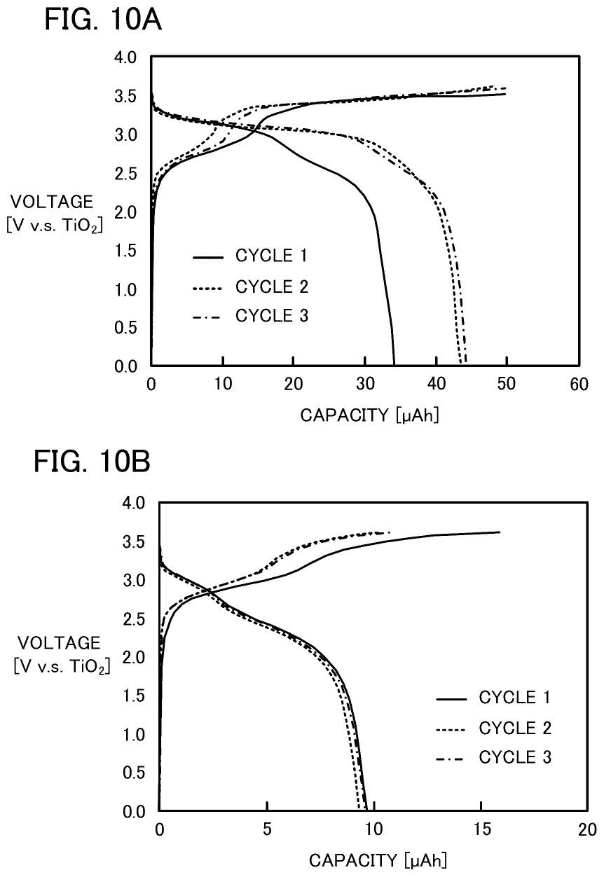

FIGS. 10A and 10B illustrate the results of the charge and discharge measurements conducted under the above conditions. FIGS. 10A and 10B are examples of the charge and discharge curve diagrams of the solid-state batteries. FIG. 10A illustrates an example of a charge and discharge curve diagram of the solid-state battery with the buffer layers. FIG. 10B illustrates an example of a charge and discharge curve diagram of the solid-state battery without the buffer layers.

It was seen from FIG. 10A that the solid-state battery 1A in which a buffer layer 30A was formed between the silica-based glass material 20A and each outermost negative electrode layer 12 and which was designed to have a discharge capacity of 45 μAh in five parallel rows obtained a discharge capacity nearly as designed. In contrast, it was seen from FIG. 10B that the solid-state battery which was designed to have a discharge capacity of 45 μAh in five parallel rows and which was formed without the buffer layers 30A failed to obtain a sufficient discharge capacity. From the results illustrated in FIGS. 10A and 10B, it is seen that forming a buffer layer 30A between the silica-based glass material 20A and each outermost negative electrode layer 12 makes it possible to effectively reduce deterioration in charge and discharge characteristics of the solid-state battery 1A.

### (Crack Evaluation)

A crack was generated inside the solid-state battery 1A in which a buffer layer 30A was formed between each outermost negative electrode layer 12 of the multi-layer body 10A and the silica-based glass material 20A covering the multi-layer body 10A, and the cross section of the solid-state battery 1A was observed with a microscope.

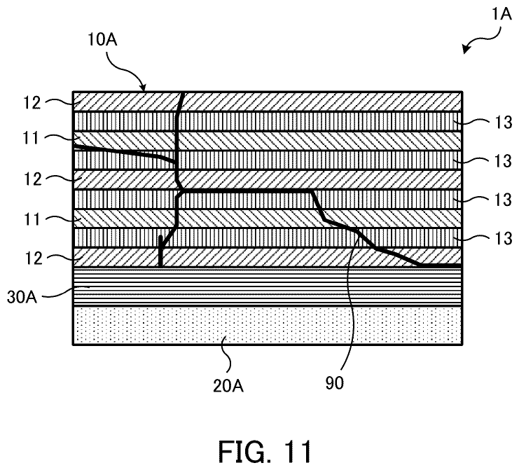

FIG. 11 illustrates the result of the observation with the microscope. FIG. 11 schematically illustrates an example of a microscope image of the solid-state battery. FIG. 11 schematically illustrates an example of a sectional microscope image of the solid-state battery including a crack.

As illustrated in FIG. 11, in the solid-state battery 1A in which a buffer layer 30A was formed between each outermost negative electrode layer 12, which faces a positive electrode layer 11 via a solid electrolyte layer 13, and the silica-based glass material 20A, it was seen that, even when a crack 90 was generated in the multi-layer body 10A inside the solid-state battery 1A, the extension of the crack 90 was prevented by the buffer layers 30A. From the result illustrated in FIG. 11, it is seen that forming a buffer layer 30A between the silica-based glass material 20A and each outermost negative electrode layer 12 makes it possible to effectively prevent the crack 90 generated in the multi-layer body 10A from extending into the silica-based glass material 20A, which is the outermost surface layer of the solid-state battery 1A.

### (Consideration)

As described with reference to FIGS. 9A and 9B, compared with the solid-state battery in which no buffer layers 30A are formed, in the solid-state battery 1A in which a buffer layers 30A is formed between each outermost negative electrode layer 12 and the silica-based glass material 20A, the buffer layers 30A reduce diffusion of heterogeneous elements between the outermost negative electrode layers 12 and the silica-based glass material 20A and resultant formation of insufficiently sintered layers. This makes it possible to reduce decrease in the utilization rate of the negative electrode active materials in the negative electrode layers 12. As a result, it is possible to obtain a sufficient discharge capacity and to reduce deterioration in charge-discharge characteristics. Furthermore, even if the crack 90 is generated in the multi-layer body 10A inside the solid-state battery 1A, it is possible to prevent the crack 90 from extending beyond the buffer layer 30A. This reduces damage to the silica-based glass material 20A, resultant decrease in mechanical strength of the solid-state battery 1A, and entry of moisture or gas, for example.

The description has been made on an example in which the solid-state battery 1A includes the multi-layer body 10A including the negative electrode layers 12 as the outermost layers and including the buffer layers 30A formed between the negative electrode layers 12 of the multi-layer body 10A and the silica-based glass material 20A. The same advantageous effects as described above are obtained from a solid-state battery that includes a multi-layer body including the positive electrode layers 11 as the outermost layers and including the buffer layers 30A formed between the positive electrode layers 11 of the multi-layer body and the silica-based glass material 20A.

According to one aspect, it is possible to realize a solid-state battery that uses a silica-based glass material and exhibits excellent battery characteristics.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that various changes, substitutions, and alterations could be made hereto without departing from the spirit and scope of the disclosure.

What is claimed is:

1. A solid-state battery comprising:
a multi-layer body in which at least two electrode layers and at least one solid electrolyte layer are alternately stacked and in which two of the electrode layers are located as outermost electrode layers;
a silica-based glass material that covers the multi-layer body; and
an insulating buffer layer that is provided between each of the outermost electrode layers of the multi-layer body and the silica-based glass material.

2. The solid-state battery according to claim 1, wherein the at least two electrode layers of the multi-layer body include a positive electrode layer containing a positive electrode active material and a first solid electrolyte, and a negative electrode layer containing a negative electrode active material and a second solid electrolyte.

3. The solid-state battery according to claim 2, wherein at least one of the outermost electrode layers of the multi-layer body is the negative electrode layer.

4. The solid-state battery according to claim 1, wherein the buffer layers are each a layer for which a third solid electrolyte is used.

5. The solid-state battery according to claim 1, wherein the silica-based glass material contains SiO₂ and at least one of LiO₂, Na₂O, K₂O, or B₂O₃.

6. The solid-state battery according to claim 1,
wherein part of each of the at least two electrode layers of the multi-layer body is exposed to outside from the silica-based glass material, and
wherein the solid-state battery includes an external electrode connected to at least one of the parts exposed to outside from the silica-based glass material.

7. A solid-state battery manufacturing method, comprising:
forming a structure including
a multi-layer body in which at least two electrode layers and at least one solid electrolyte layer are alternately stacked and in which two of the electrode layers are located as outermost electrode layers,
a silica-based glass material that covers the multi-layer body, and
an insulating buffer layer that is formed between each of the outermost electrode layers of the multi-layer body and the silica-based glass material; and
firing the structure.

8. The solid-state battery manufacturing method according to claim 7, wherein the buffer layers are each a layer for which a solid electrolyte is used.

9. The solid-state battery manufacturing method according to claim 7,
wherein part of each of the at least two electrode layers of the multi-layer body is exposed to outside from the silica-based glass material, and
wherein the solid-state battery manufacturing method includes forming an external electrode connected to at least one of the parts exposed to outside from the silica-based glass material after the firing of the structure.
